(19) United States
(12) Patent Application Publication
(10) Pub. No.: US 2010/0281403 A1
(43) Pub. Date: Nov. 4, 2010

(54) BROWSER PROGRAM AND TERMINAL DEVICE

(75) Inventors: Toshihiko Yamakami, Chiba (JP); Takuya Harakawa, Tokyo (JP)

Correspondence Address: MORRISON & FOERSTER LLP, 425 MARKET STREET, SAN FRANCISCO, CA, 94105-2482, US

(73) Assignee: ACCESS CO., LTD., Chiyoda-ku, Toyko (JP)

(21) Appl. No.: 12/810,820

(22) PCT Filed: Dec. 25, 2008
(86) PCT No.: PCT/JP2008/073612

§ 371 Date: Jun. 25, 2010

(30) Foreign Application Priority Data
Dec. 28, 2007 (JP) 2007-338702

(51) Int. Cl. G06F 3/048

(52) U.S. Cl. 715/760

(57) ABSTRACT

A computer-executable browser program, which generates drawing data for displaying contents on a display in accordance with contents data described in markup language, is provided with plurality of browser modules in which different functions are implemented, and a browser module managing unit that manages the plurality of the browser modules. One of a plurality of the browser modules is a rendering module to carry out rendering contents data for generating drawing data. At least one of a plurality of the browser modules is such a module as exclusively used for substituting for or changing a part of a rendering module or adding a separate function to functions of the rendering module. The browser module managing unit determines to process an element included in the contents data by using any of the exclusive modules in accordance with a predetermined condition so as to provide what makes a rendering module process such a thing that a predetermined change is added to the contents data.

### TECHNICAL FIELD

The present invention relates a browser for rendering contents and a terminal device on which such a browser is installed, particularly to a browser program and a terminal device which make an open source browser module and a non-open source browser module cooperate with each other to render contents.

### BACKGROUND OF THE INVENTION

Information browsing software programs (hereafter, referred to as a “browser”) for browsing information (primarily, information configured as a data group integrated by a markup language) on a network have been well known and have been practically used. On the browser, a function of analyzing information on a network (e.g., a Web page which is a document described in a markup language, such as an HTML (Hyper Text Markup Language) or an XHTML (Extensible Hyper Text Markup Language)), and generating data for onscreen representation (hereafter, referred to as “rendering”) based on a result of the analysis is implemented. By designating an URI (Uniform Resource Identifier), a user is able to browse a desired Web page on the browser. Such browsers have been installed on various types of devices, such as a mobile phone, a PDA (Personal Digital Assistant), and an information home appliance, as well as a PC.

Among devices on which browsers are installed, mobile phones are used by a number of users, and the market size of mobile phones is large. Each of mobile communication carriers is now trying to increase the market share by providing high value-added services for users and thereby differentiating the services from those of other companies. For this reason, each mobile communication carrier provides high value-added services for users, for example, by installing, on each mobile phone, a browser on which a unique extended function which can not be realized by a standard technology is implemented, and thereby enhancing the function and performance of each mobile phone.

Due to such circumstances of the mobile communication carriers, a vender who provides browsers to the mobile communication carriers is required to develop separately browsers respectively complying with specifications the mobile communication carriers. In order to develop such a dedicated browser for each of the mobile communication carriers, the vender is required to enhance the development efficiency of browsers by avoiding duplicated development of browsers regarding functions common to the mobile communication carriers, and thereby reducing the development man-power.

Incidentally, introduction of a development way of developing unique software while avoiding duplicated development of modules responsible for general purpose functions by utilizing open source software has been rapidly advancing in recent years in order to enhance the development efficiency of software. For example, a browser engine such as Webkit (The Webkit Open Source Project http://webkit.org [browsed on Dec. 21, 2007]) has been made as open source software, and we are now in circumstances where anyone can freely develop a unique browser by using such open source software. Therefore, the vender intends to enhance the development efficiency of the browser and thereby to achieve reduction in lead time and cost reduction, by utilizing the open source software.

In general, due to a licensing agreement on open source software, when the open source software is modified, a creator is obliged to open source codes of the altered software. Therefore, when the vender has developed a derivative browser by modifying the open source software, the vender is supposed to open source codes of the derivative browser.

### DISCLOSURE OF THE INVENTION

However, for differentiation from other companies and for security, the mobile communication carrier wants to conceal source codes of the extended function unique to the carrier and the function restricted due to system operation. That is, the development way of developing a derivative browser by modifying an open source browser is extremely effective in regard to the development efficiency, but is not appropriate for developing a browser for a mobile phone in regard to terms in the licensing agreement.

On the other hand, the mobile communication carrier requires the vender to soon implement functions realized by the open source browser on the dedicated browser for the mobile communication carrier. Therefore, the vender is required to carry out, for the mobile communication carrier, software development for implementing the functions realized by the open source browser on the dedicated browser, in addition to developing software for realizing the extended function unique to the mobile communication carrier. However, when the functions of the open source software are implemented on the dedicated browser, there are concerns about decrease in quality of a browser, increase of a development load, increase of a lead time, and cost increase caused by increase of complexity of a program structure.

In consideration of the above described circumstances, the object of the present invention is to provide a browser program capable of achieving functions of a latest open source browser and supporting unique extended functions and specifications without modifying the open source browse, by executing an open source browser engine and non-open source modules in corporation with respect to each other, and to provide a terminal device on which the browser program is installed.

According to an embodiment of the present invention, there is provided a browser program executable on a computer which generates drawing data for displaying contents described in a markup language on a display based on contents data, comprising: a plurality of browser modules on which different functions are implemented respectively; and a browser module management unit which manages the plurality of browser modules, wherein one of the plurality of browser modules is a rendering module which generates the drawing data by rendering the contents data; at least one of the plurality of browser modules is a dedicated module which replaces or changes a part of functions of the rendering module or adding another function to the functions of the rendering module; and the browser module management unit determines which of dedicated modules should be used to process elements included in the contents data, and to cause the rendering module to process the contents data on which predetermined alteration is made.

According to the browser program configured as described above, a browser module to be used to process contents is determined based on a predetermined condition. Therefore, by appropriately setting the condition, it becomes possible to process contents by selectively and appropriately using various types of browser modules such as an open source browser module and a non-open source browser module. Consequently, it becomes possible to achieve both of reduction of a development load on a vender through utilization of an open source browser module and securing of confidentiality of source codes of the extended function provided by implementing a unique extended function of a mobile communication carrier on a non-open source browser.

In an embodiment of the invention, the browser module management unit comprises: an element extraction unit which searches the contents data to extract the elements to be processed by using the dedicated module; a content data alteration unit which makes the predetermined alteration on the contents data based on a result of extraction by the element extraction unit; a module invocation unit which invokes the dedicated module corresponding to the alteration; and a content transmission unit which passes the altered contents to the rendering module. The rendering module causes the invoked dedicated module to process an altered part of the contents, and renders the contents by using a result of the execution by the dedicated module.

The content data alteration unit may insert, into the contents data, a predetermined element to which predetermined control information is added. The predetermined control information may be information for calling the dedicated module and adding a function of the dedicated module to the functions of the rendering module. The predetermined control information may include identification information which the dedicated module uses to access the predetermined element.

It is preferable that the content data alteration unit makes the predetermined alteration within a scope where the rendering module is able to analyze the contents.

In an embodiment of the invention, a request to a server is sent by the rendering module, and the browser module management unit manages intercepts a response to the request, and executes an element extraction process by the element extraction unit, a content alteration process by the content data alteration unit, a browser module invocation process by the module invocation unit, and a content transmission process by the content transmission unit.

The rendering module is an open source browser module.

Codes describing the above mentioned browser program may be described in various types of programming languages, such as, C language, C++ language, and Java®. Furthermore, the codes describing the above mentioned browser program include firmware stored in a RAM, ROM and a flash memory. Furthermore, the codes include codes recorded on a computer readable recording medium, such as a magnetic tape, a floppy disk, a hard disk, a compact disc (CD), a magnetic optical disc, a digital versatile disc (DVD), a flash memory, and etc. Furthermore, according to an embodiment of the invention, there is provided a computer readable recording medium on which the above mentioned browser program is recorded.

According to an embodiment of the invention, there is provided a terminal device, comprising: a storage means that stores a browser program according to claim 1; a browser program execution means that executes the browser program stored in the storage means; and a display means that displays a rendering result by the executed browser program.

According to the terminal device configured as described above, a browser module to be used to process contents is determined based on a predetermined condition. Therefore, by appropriately setting the condition, it becomes possible to process contents by selectively and appropriately using various types of browser modules such as an open source browser module and a non-open source browser module. Consequently, it becomes possible to achieve both of reduction of a development load on a vender through utilization of an open source browser module and securing of confidentiality of source codes of the extended function provided by implementing a unique extended function of a mobile communication carrier on a non-open source browser.

According to the embodiments of the invention, it becomes possible to provided a browser program and a terminal device which are able to achieve both of reduction of a development load on a vender through utilization of an open source browser module and securing of confidentiality of source codes of the extended function provided by implementing an unique extended function of a mobile communication carrier on a non-open source browser.

### BRIEF DESCRIPTION OF THE DRAWINGS

FIG. 1 illustrates a general outer appearance of a terminal device according to an embodiment of the invention.

FIG. 2 is a block diagram illustrating a general configuration of the terminal device according to the embodiment of the invention.

FIG. 3 is a data flowchart for explaining processing executed until Web contents obtained in accordance with an accessing operation for accessing are displayed on a display, according to the embodiment of the invention.

FIG. 4 is a flowchart illustrating a rendering process of Web contents executed by an open source browser engine module according to the embodiment of the invention.

FIG. 5 is a data flowchart explaining a processing flow of a process executed until the Web contents obtained in accordance with the accessing operation are displayed on the display.

### BEST MODE FOR CARRYING OUT THE INVENTION

In the following, an embodiment according to the present invention will be explained with reference to the accompanying drawings.

First of all, technical terms used herein are defined as follows. Network: Various types of networks including a mobile communication network of a mobile communication carrier, an intranet and the Internet.

Contents: a group of information including video, an image, sound, a document, data such as a work sheet or a combination thereof to be browsed by a user. Contents are transmitted through a network or is stored in a terminal device.
Web contents: a form of contents. The Web contents are a group of information created or browsed by utilizing Web technology.
Web page: a form of Web contents. The Web page represents an entire content to be displayed when a user designates an URL. That is, the Web page represents an entire content which can be displayed by scrolling onscreen representation on a display. The Web page includes not only a Web page being browsed online but also a Web page being browsed offline. The Web page being browsed offline includes, for example, a page which is cached by a browser after having been received from the Internet, or a page stored, for example, in a local folder of a terminal device in an mht format. The Web page includes various types of information (Web page data), such as, an HTML document, an XHTML document, an image file, sound data and etc.

According to the above described definitions, contents include Web contents, and Web contents include a Web page.

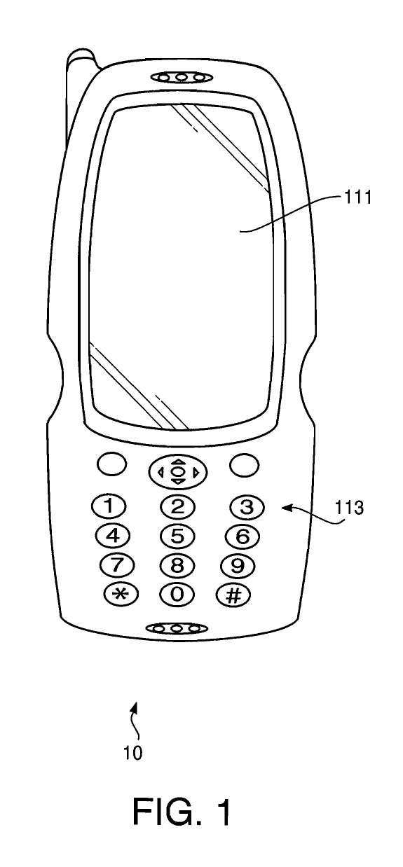

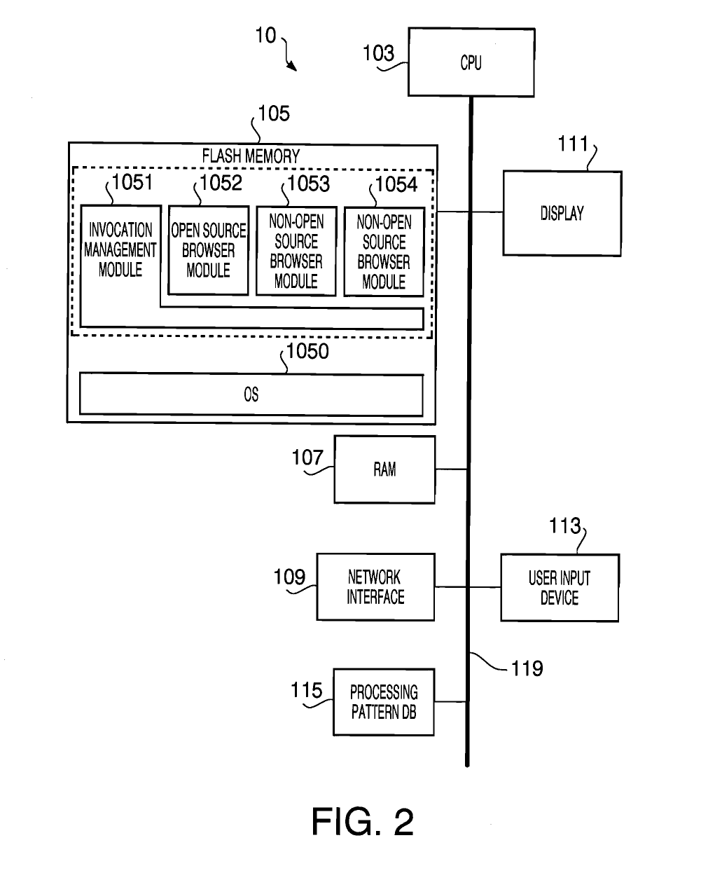

FIG. 1 illustrates a general outer appearance of a terminal device 10 according to the embodiment of the invention. FIG. 2 is a block diagram illustrating a general configuration of the terminal device 10. Although the terminal device 10 is configured as a mobile phone, the present invention may also be implemented on various types of terminals, such as, a PDS, PHS (Personal Handy phone System), a portable game machine, a home appliance and etc, on which a browser has been installed.

As shown in FIG. 2, the terminal device 10 includes a CPU (Central Processing Unit) 103 which totally controls the entire device. To the CPU 103, each of components of the terminal device 10 is connected via a bus 119. The CPU 103 achieves various functions by executing data communication with another component via the bus 119. These components include a flash memory 105, a RAM (Random-Access Memory) 107, a network interface 109, a display 111, a user input device 113 and a processing pattern DB (Data Base) 115. The bus 119 further includes a power supply line. Each component of the terminal device 10, such as the CPU 103, is supplied with power from a battery (not shown) via the power supply line.

The flash memory 105 stores an OS (Operating System) 1050 which manages the entire terminal device 10, and a plurality of program modules running on the OS 1050 (including a invocation management module 1051 and a plurality of invoking modules).

The invocation management module 1051 manages totally the plurality of invoking modules. The plurality of invoking modules include an open source browser engine module 1052 such as Webkit, and a non-open source dedicated modules 1053, 1054 for processing extended functions and specifications unique to the mobile communication carrier.

Each of the invocation management module 1051, the open source browser engine module 1052 and the non-open source dedicated modules 1053, 1054 may be configured as a single program module or may be configured as a group of segmented program modules.

The RAM 107 is a non-volatile memory, and functions as work space, i.e., a loading target, into which a program or various types of data to be used by the CPU 103 is loaded. For example, when an operation for accessing Web contents is conducted through the user input device 113, the invocation management module 1051, the open source browser engine module 1052 and the non-open source dedicated modules 1053, 1054 are loaded into a work area of the RAM 107 as appropriate, and these modules run in cooperation with each other so that these modules are able to function apparently as a single browser for browsing online or offline contents described in a markup language, such as HTML or XHTML. More specifically, only the invocation management module 1051 runs directly on the OS 1050, and the open source browser engine module 1052 and the non-open source dedicated modules 1053, 1054 . . . run on the invocation management module 1051. Therefore, the OS 1050 recognizes only the invocation management module 1051 as a single browser. Outputs from each of the modules 1052, 1053 and 1054 are passed to the OS 1050 via the invocation management module 1051, and inputs from the OS 1050 are passed to each of the modules 1052, 11053 and 1054 via the invocation management module 1051. In the following explanation, an operation where inputs, which would be directly passed from the OS 1050 to the browser engine in a conventional system, is received by the invocation management module 1051 between the OS 1050 and the browser engine is referred to as “intercept”. A group of modules which operate in cooperation with each other as a single browser is referred to as a combined browser 1055. As a result of processing by the combined browser 1055, drawing data for displaying Web contents on the display 111 is generated and is transmitted to the display 111. Consequently, a user becomes able to conduct Web browsing through the display 111 on which Web contents are displayed based on the drawing data. That is, a user becomes able to browse Web contents through the display 111.

Incidentally, the browser engine module 1052 is an open source module, and is configured to be able to provide general-purpose functions generally implemented on browsers for mobile phones for many mobile communication carriers. On the other hand, the non-open source dedicated modules 1053, 1054 are proprietary non-open source modules of a vender, and are configured to provide expanded functions unique to the mobile communication carrier and to function so as to enable the combined browser 1055 to operate in conformity with the unique specifications of the mobile communication carrier. That is, the unique expanded functions and the functions complying with the unique specifications of the mobile communication carrier are realized by the non-open source dedicated modules. The non-open source dedicated modules provide different types of expanded functions, respectively.

In the processing pattern DB 115, patterns (hereafter, referred to as “extended function patterns”) of the unique extended functions of the mobile communication carrier and processing patterns (hereafter, referred to as “specification patterns”) for making Web contents comply with the unique specifications of the mobile communication carrier, and rules for determining which of the invoking modules should be invoked to execute processing, such as a rendering, by using these processing patterns are stored as a database. In this embodiment, the processing pattern DB 115 is configured as a storage device (e.g., a second detachable flash memory) provided separately from the flash memory 105. However, in another embodiment, the processing pattern DB 115 may be configured as a part of the combined browser 1055.

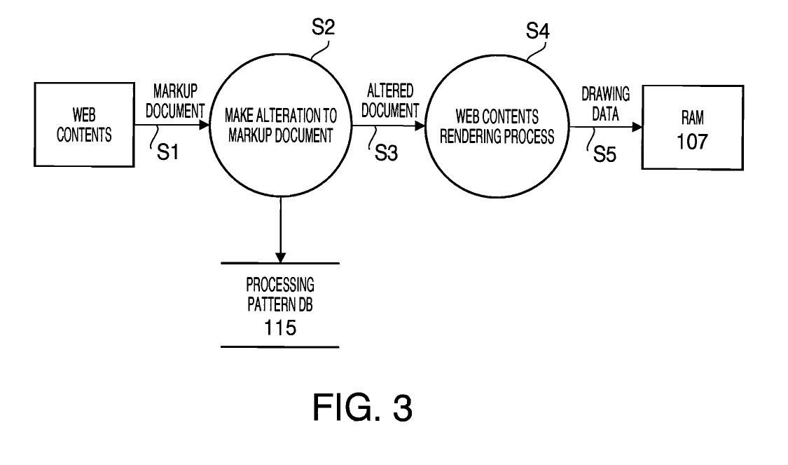

Next, processing to be executed by each program module when an operation for accessing Web contents is conducted is explained. FIG. 3 is a data flowchart for explaining processing executed until Web contents obtained in accordance with an operation for accessing are displayed on the display 111. In the following explanations and drawings, each processing (step) is abbreviated as “S”.

When an operation for accessing Web contents is conducted (e.g., when an URL is inputted through the user input device 113, when a URL is designated by selecting an anchor on Web contents, or when a URL stored in the terminal device 10 as a bookmark or a history selected), the open source browser engine module 1052 generates a request message for requesting resources such as Web contents, which complies with HTTP (Hypertext Transfer Protocol), and transmits the request message to a designated URL on a network.

Next, a server corresponding to the designated URL generates a response message responsive to the received request message, and returns the response message. When the response message is received by the terminal device 10 via the network, the invocation management module 1051 intercepts the response message (S1). In a message body of the response message, a markup document which has been designated by the URL and is described in HTML or XHTML is contained.

The invocation management module 1051 executes the following processing (processing of S2) after intercepting the response message. That is, before passing the response message to the open source browser engine module 1052, the invocation management module 1051 searches the markup document in the response message to extract elements to be processed by applying the extended function pattern or the specification pattern thereto, while accessing the processing pattern DB 115 to refer to the database of the rules. Then, the invocation management module 1051 executes processing described below by way of example when an element to be processed by applying the extended function pattern or the specification pattern thereto is extracted.

### Processing Example 1

Consider the case where there is a specification (“the number of radio buttons of a form element is limited to a value lower than or equal to 16”) unique to a carrier. In this case, the invocation management module 1051 changes a form element having the number of radio buttons larger than 16 (for example, the invocation management module 1051 deletes at least one form control so that the number of controls (input elements) having a type attribute value of “radio” becomes 16).

### Processing Example 2

Consider the case where there is a specification (“the acceptable number of letters to be input defined for a textarea element is limited to a value lower than or equal to 4 column×20 letters”) unique to a carrier. In this case, when a markup document includes a textarea element, e.g., “<textarea name=“impressions” rows=“10” cols=“40”> Please input your impressions here. </textarea>”, the invocation management module 1051 changes the textarea element to “<textara name=“impressions” rows=“4” cols=“20”> Please input your impressions here. </textarea>”.

### Processing Example 3

Consider the case where there is a specification (“for an element <a href=“http://foo.bar.com/program.cgi? action=q” terminalid>, a terminal ID set as tid is transmitted to a Web site”) unique to a carrier. In order to transmit the terminal ID to the accessed Web site, the invocation management module 1051 reads the terminal ID (e.g., z0878e0003a99) for example from a SIM card (Subscriber Identity Module Card) of the terminal device 10, and changes an a-element <a href=“http://foo.bar.com/program.cgi?action=q” terminalid> to <a href=“http://foo.bar.com/program.cgi?action=q&tid=z0878e0003a99”>, and inserts the converted a-element into the markup document in place of the original a-element of the markup document. The advantages of this process are described later.

### Processing Example 4

Consider the case where, in addition to the specification of the above described <Processing Example 3>, there is a specification for checking, with a user, a transmission permission of a terminal ID for each execution of transmission. The invocation management module 1051 firstly reads the terminal ID (e.g., z0878e0003a99) from the SIM card, and then writes the read terminal ID and codes for executing Javascript™ into <a href://foo.bar.com/program.cgi?action=q” terminalid>. Specifically, the invocation management module 1051 changes the above described a-element of the markup document to <a href=“http:://foo.bar.com/program.cgi?action=q&tid=z0878e003a99” onclic=“userconfirmwithtext (‘Do you accept to transmit a terminal ID?’)”>. Then, the invocation management module 1051 inserts the converted a-element into the markup language in place of the original a-element of the markup document.

After processing S2 shown in the processing examples 1-4, the invocation management module 1051 passes the processed markup document to the open-source browser engine module 1052 (S3).

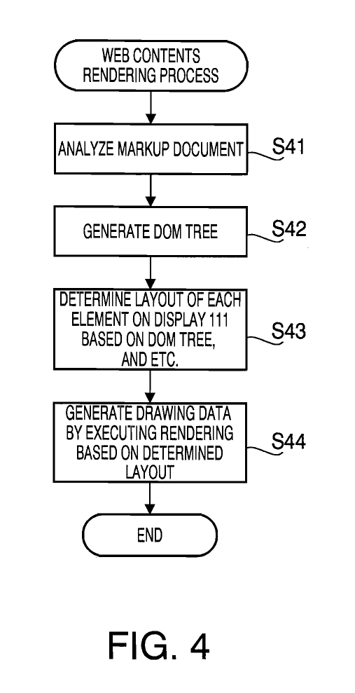

FIG. 4 is a flowchart illustrating a rendering process of Web contents, i.e., processing S4 in FIG. 3, executed by the open source browser engine module 1052.

As shown in FIG. 4, the open source browser engine module 1052 analyzes the received markup document (S41), and generates a document tree, such as a DOM (Document Object Model) tree, describing a logical structure in a tree structure of the markup document to load the created document tree in the RAM 107 (S42). Then, the browser engine module 1052 determines a layout for each item on the display 11 based on the information, such as a DOM tree, a tag, a style sheet loaded into the RAM 107 (S43). The open source browser engine module 1052 executes the rendering based on the determined layout, and generates drawing data (S44). The drawing data generated as described above is loaded into a video memory area of the RAM 107 as shown in FIG. 3 (S5). Thus, the requested Web contents located at the designated URL are displayed on the display 111.

As described above, the invocation management module 1051 processes the markup document such that the processed markup language has a document structure which the open source browser engine module 1052 is able to analyze and which meets the specification unique to the mobile communication carrier, and passes the processed markup document to the open source browser engine module 1052. Therefore, in the processing examples 1 and 2, the Web contents are displayed on the display 111 in the state where the Web contents meet the specification, regardless of a fact that the open source browser engine module 1052 does not support the specification unique to the mobile communication carrier. In the process examples 3 and 4, the open source browser engine module 1052 operates in accordance with the specification unique to the mobile communication carrier.

Specifically, in the process example 1, the Web contents are displayed on the display 111 in the state where the number of radio buttons of all the form elements in the Web contents is limited to the value smaller than or equal to sixteen. In the processing example 2, the Web contents are displayed on the display 111 in the state where the acceptable number of letters to be input defined for a textarea element is limited to a value lower than or equal to 4 column×20 letters.

In the process example 3, the open source browser engine module 1052 transmits, to a server distributing the Web contents, a message for instructing the server to execute a CGI (Common Gateway Interface) program designated by the above described a-element by using the terminal ID “z0878e0003a99” as an argument, in response to a user operation. In the processing example 4, the open source browser engine module 1052 calls a function “userconfirmwithtext( )” in response to occurrence of an onclick event. As a result, “userconfirmwithtext( )” is executed and a confirmation message (“Do you accept to transmit a terminal ID?”) is displayed on the display 111. When a user operation for confirming the displayed message is conducted, the open source browser engine module 1052 transmits a message requesting for execution of the CGI program by using the terminal ID “z0878e0003a99” as an argument.

That is, according to the combined browser 1055 of the embodiment, the function of processing a markup document to meet the specification unique to the mobile communication carrier is implemented on the invocation management module 1051, and the general-purpose function is implemented on the open source browser engine module 1052. By employing the above mentioned program structure, i.e., a program structure for assigning only the general-purpose functions to an open source browser engine, such as Webkit, the vender is not required to privately develop a dedicated module for implementing general-purpose functions. General purpose functions of the combined browser evolve with development of open source browsers, without requiring the vender to privately develop the general-purpose functions. On the other hand, regarding the extended functions and the specification unique to the mobile communication carrier, the vender privately develops them with non-open source software. Therefore, the vender is not required to open source codes of the unique extended function and specification, which satisfies the requirement of the mobile communication carrier who wants to conceal the extended function and the unique specification. In another embodiment, the process of S2 in FIG. 3, i.e., the process for extracting, from the markup document, elements for which the extended function pattern and the specification pattern should be applied and for changing the elements in accordance with the pattern may be executed by a dedicated module in place of the invocation management module. In this case, when the invocation management module 1051 intercepts the markup document, the invocation management module 1051 passes the markup document to the dedicated module. Further, when the invocation management module 1051 receives the processed markup document which is returned by the dedicated module for processing, the invocation management module 1051 passes the processed markup document to the open source browser engine module 1052 to execute rendering.

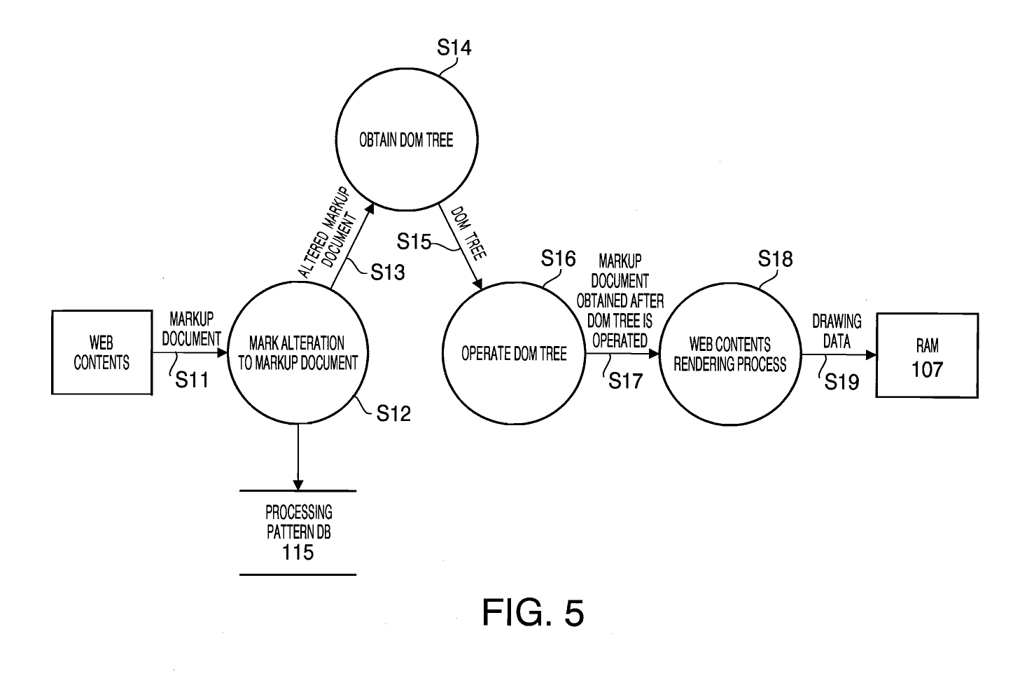

Next, another processing of a data flowchart shown in FIG. 3 is explained with reference to a data flowchart shown in FIG. 5. Similarly to FIG. 3, FIG. 5 is a data flowchart explaining a processing flow of a process where the Web contents are displayed on the display 11.

In the example shown in FIG. 5, similarly to S1 in FIG. 3, the invocation management module 1051 firstly intercepts a response message (S11). Then, the invocation management module 1051 executes a process of S12 to change the markup document as in the case of S2 in FIG. 3. That is, the invocation management module 1051 accesses the processing pattern DB 115 before passing the markup document to the open source browser engine module 1052, and extracts elements to be processed by applying the extended function pattern or the specification pattern while referring to the rules in the database. When the elements to be processed by applying the extended function pattern or the specification pattern are extracted, the invocation management module 1051 executes the following processes (processing examples 5 and 6).

### Processing Example 5

Consider the case where there is an extended function (to set a skin of a browser by a unique element <mobilebackground img=“fujisan.jpg”>) unique to the mobile communication carrier. In this case, the invocation management module 1051 makes changes to add an id attribute (or a class attribute) to <mobilebackground img=“fujisan.jpg”>. That is, the invocation management module 1051 changes <mobilebackground img=“fujisan.jpg”> to <a id=“xx889” href=“mobilebackground:fujisan.jpg”>, and inserts the a-element obtained by the conversion into the body element of the markup document in place of the original a-element of the markup document.

### Processing Example 6

Consider the case where there is an extended function (to set a background music of Web contents by an element <mobilebackground audio=“march.mp3”>) unique to the mobile communication carrier. In this case, the invocation management module 1051 adds an id attribute to the element <mobilebackground audio=“march.mp3”>. That is, the invocation management module 1051 changes <mobilebackground audio=“march.mp3”> to <a id=“xx889” href=“mobilebackgroundaudio:march.mp3”>, and inserts the a-element obtained by the conversion into the body element of the markup document in place of the original a-element of the markup document.

After executing the process of S12 shown in the processing examples 5 and 6, the invocation management module 1051 passes the processed markup document to the open source browser engine module 1052 (S13). Further, based on the rules in the database of the processing pattern DB 115, the invocation management module 1051 invokes, in the processing example 5, the non-open source dedicated modules 1053 on which the extended function of the skin setting is implemented, and invokes, in the processing example 6, the non-open source dedicated modules 1054 on which the extended function of the background music setting is implemented.

Next, the open source browser engine module 1052 analyzes the received markup document to generate a DOM tree (S14), and loads the DOM tree into the RAM 107 (S15). Then, the non-open source dedicated module (1053, 1054) invoked by the invocation management module 1051 executes the following processing (process of S16).

In the processing example 5, the non-open source dedicated module 1053 refers to each node along the DOM tree loaded into the RAM 107, and accesses a node to which the id attribute is added (i.e., a node to which the id attribute “xx889” is added). The non-open source dedicated module 1053 accesses the data of “mobilebackground:fujisan.jpg” to download the file “fujisan.jpg”, and stores a downloaded file in a predetermined local folder. Then, the non-open source dedicated module 1053 deletes the node <a id=“xx889” href=“mobilebackground:fujisan.jpg”> from the DOM tree.

In the processing example 6, the non-open source dedicated module 1054 refers to each node along the DOM tree loaded into the RAM 107, and accesses a node to which the id attribute is added (i.e., a node to which the id attribute “xx889” is added). The non-open source dedicated module 1054 accesses the data of “mobilebackgroundaudio:march.mp3” to download the file “march.mp3”, and stores the downloaded file in a predetermined local folder. Then, the non-open source dedicated module 1054 deletes node <a id=“xx889” href=“mobilebackgroundaudio:march.mp3”> from the DOM tree.

Subsequently, the open source browser engine module 1052 executes. Specifically, the open source browser engine module 1052 determines a layout of each element on the display 111 based on the information, such as the DOM tree from which the node having the id attribute is deleted, the tag and the style sheet, and executes the rendering based on the determined layout to generate the drawing data (S17, 18). The drawing data generated as described above is loaded into the video memory area of the RAM 107 (S19). Thus, the requested Web contents located at the designated URL are displayed on the display 111. Furthermore, when image data or sound data is stored in the predetermined local folder, the open source browser engine module 1052 automatically reads these data in the process of S18, automatically sets the image data as a skin and sets the sound data as background music. Regarding the processing example 5, in the process of S18, the open source browser engine module 1052 accesses the “fujisan.jpg” stored in the local folder, and sets the image of “fujisan.jpg” as a skin. Furthermore, regarding the processing example 6, in the process of S18, the open source browser engine module 1052 accesses the “march.mp3” stored in the local folder, and sets the “march.mp3” as background music. While the Web contents are displayed on the display 111, music of “march.mp3” is reproduced.

As described above, the invocation management module 1051 controls the non-open source dedicated module to execute the process corresponding to the extended function unique to the mobile communication carrier, and controls the open source browser engine module 1052 to execute the process which the open source browser engine module 1052 is able to process. In other words, the open source browser engine module 1052 renders the Web contents in the state where the function of the non-open source dedicated module is added thereto by the invocation management module 1051. In the embodiment shown in FIG. 5, the working load for development by the vender can be reduced by utilizing the open source browser engine such as Webkit as in the case of the embodiment shown in FIG. 3. Further, the combined browser 1055 which meets the requirement for conceding source codes of the unique specification and the extended function can be provided. In another embodiment, S12 in FIG. 5, i.e., the process in which the elements to be processed by applying the extended function pattern or the specification pattern are extracted from the markup document, may be executed by a dedicated module for a pre-process, not by the invocation management module 1051. In this case, when the invocation management module 1051 intercepts the markup document, the open source browser engine module 1052 firstly passes the markup document to the dedicated module for a pre-process, and when receiving the changed markup document from the dedicated module for a pre-process, the invocation management module 1051 passes the received markup document to the open source browser engine module 1052 to generate the DOM tree. Then, the invocation management module 1051 causes the dedicated modules 1053 and 1054 to process the DOM tree and causes the open source browser engine module 1052 to execute the rendering.

The terminal device 10 stores data having information with a high degree of confidentiality, such as a telephone book. When it is necessary to access such data having a high degree of confidentiality, a process where a security aspect is considered is needed. In the embodiment, information having a high degree of confidentiality is protected by executing a process described below.

### Security Example 1

Consider the case where there is execution of an interface (i.e., “Phonebook.delete (i, securitykey))” is allowed from the inside of the terminal only and where an item of the phonebook is deleted by executing Phonebook.delete (i, securitykey) when an element <phonebookdelete param“1”> is provided. When an element <phonebookdelete param=“2”> is provided in the intercepted response message, the invocation management module 1051 converts <phonebookdelete param=“2”>, for example, into <a onclick=“phonebookdelete(2, ‘#cell3fed3’>, and inserts the converted a-element into the body element of the mark-up document in place of the original a-element of the markup document. Furthermore, the invocation management module 1051 calls the next non-open source dedicated module described in Javascript, inserts it into the head element of the markup document, and passes the markup document to the open source browser engine module 1052. It should be noted that “#cell3fed3” is a security key (a hash value) generated by applying a hash to a data set including three pieces of data of “current time (data representing a current date and time on an hour-by-hour basis)”, “a secret key” and “the byte number of Web contents (a markup document)”. The secret key is a value which is managed secretly in the inside of the terminal device 10. Use of such a security key makes it possible to limit the applicable Web contents and to set the expiration date of the security key. Furthermore, since an external device which does not know the secret key is not able to generate the security key, it becomes possible to effectively exclude unauthorized external access. Therefore, through use of such a security key, it becomes possible to secure an extremely high degree of security.

script
function phonebookdelete (arg, securitykey)
{

if (securitycheck(securitykey) == “passed”) /* “passed” is returned if security check is

OK.*/

{

if (userconfirm(arg) == “ok”) /* Check with user. If OK, “ok” is returned. */
{
Phonebook.delete(i, securitykey);
}

}
else
{
/* Security can not be checked. */
}

}
/script

Next, when an onclick event occurs after the rendering process of the Web contents in FIG. 4 is executed, the open source browser engine module 1052 executes the above described Javascript inserted into the head element. First, the open source browser engine module 1052 executes the function securitycheck(securitycheck) to generate two types of hash values, and judges whether one of the hash values is identical with “#cellfed3”. Then, when it is judged that one of the hash values is identical with “#cell3fed3”, the open source browser engine module 1052 checks with the user as to whether deletion of the telephone book is allowed by the function userconfirm(arg), and only when the user permits it (only when it is OK), the open source browser engine module 1052 deletes the telephone book by the command Phonebook.delete(i, securitykey). Specifically, by the command Phonebook.delete( ) the following processes (1)-(5) are executed.
(1) Create a hash value from the data set including the three pieces of data of “current time”, “secret key” and “byte number of Web contents”.
(2) Create a hash value from the data set including three pieces of data of “time 30 minutes ago”, “secret key” and “byte number of Web contents”.
(3) Match the hash values generated in (1) and (2) with the security key “#cell3fed3”.
(4) Return “rejected” when each of the hash values is not identical with the security key “#cell3fed3”.
(5) Return “passed” when one of the hash values is identical with the security key “#cell3fed3”.
When “passed” is returned, the open source browser engine module 1052 deletes the item of the telephone book. When “rejected” is returned, the open source browser engine module 1052 does not delete the item of the telephone book. When the command Phonebook.delete(i, securitykey) is directly sent from the sever to the terminal device 10, the command is executed in the terminal device 10. However, since the sever does not know “secret key”, an error occurs in the matching process for the security key, and in this case only “rejected” is returned as described above in (4) and it is impossible to delete, form the server, the item of the telephone book of the terminal device 10. Therefore, it is necessary to use the element <phonebookdelete param=“i”> to externally delete the item of the telephone book. Since in this case user confirmation is required before the command Phonebook.delete(i,securitykey) is executed, it is possible to prevent the item of the telephone book from being deleted against the user's intention. By thus executing the process considering the security aspect, it is possible to prevent the item of the telephone book of the terminal device 10 from being deleted by vicious codes against the user's intension.

### Security Example 2

In the case where the specification similar to the security example 1 exists, if an element <phonebook delete param=“2”> is provided in the intercepted response message, the invocation management module 1051 converts <phonebook delete param=“2”> into <a onclick=“phonebookdelete(2, ‘#cellfed3’)”>, and inserts the a-element obtained by the conversion into the body element of the markup document in place of the original a-element of the markup document. The invocation management module 1051 inserts the script described below into the head element of the markup document, and passes the markup document to the open source browser engine module 1052. It should be noted that ‘#cellfed3’ is a security key as in the case of the security example 1.

script
function phonebookdelete (arg, securitykey)
{

Phonebook.delete(i, securitykey);

}
/script

Next, when the onclick event occurs after execution of the Web content rendering process shown in FIG. 4, the open source browser engine module 1052 executes Javascript inserted into the head element, and calls the dedicated module which is an object code of the non-open source corresponding to the command Phonebook.delete(i, securitykey). Then, the called non-open source dedicated module executes the processes equal to the processes (1)-(5) of the security example 1, and when the generated hash value is identical with the security key, the open source browser engine module 1052 displays a dialog for confirming whether deletion of the item of the telephone book is allowed. When the user conducts a user operation for allowing deletion, “passed” is returned to the browser engine module 1052. If the security key is not identical with one of the generated hash values, or if the user does not allow deletion, “rejected” is returned to the browser engine module 1052. The browser engine module 1052 deletes the item of the telephone book when “passed” is returned, and does not delete the item of the telephone book when “rejected” is returned. Regarding the security example 2, it is suitable that there is no necessity to insert a program for calculating a hash value into the head element.

It is understood that the present invention is not limited to the embodiment, and can be varied within the scope of the technical concept of the present invention. For example, the extended function and the specification unique to the mobile communication carrier are not limited to those shown in the processing examples 1-5 and the security examples 1 and 2. The extended function and the specification include the acceptable number of letters to be input to a form element, addition of visual effect to particular text such as a marquee, localizing of the input mode settings for hiragana-character and katakana-character, and prohibition of re-download of the downloaded Java program.

In the security examples 1 and 2, each of the process of the open source browser engine module 1052 and processes (1)-(5) of the non-open source dedicated modules takes a time not more than 30 minutes. Therefore, the “current time” which is a parameter for generating a hash value may be represented on an hour and minute basis, and a parameter for generating a hash value in the process (2) may be defined as “time thirty minutes ago” in place of “time one minute ago”

The above described embodiment may be expressed as follows. According to an embodiment of the invention, a browser program executable on a computer which generates drawing data for displaying contents described in a markup language on a display based on content data, comprises: a first module configured to be able to render content data in accordance with a first technical specification; and a second module which alters the content data so that the content data is rendered in accordance with a second technical standard.

Typically, the first technical specification is, for example, a public technical specification, as represented by HTML, XML and DOM standardized by W3C (World Wide Web Consortium) and etc. and a standard technology, such as, Javascript, which is a de facto standard. Typically, the second technical specification is a private technical standard defined uniquely by a system operator, such as a mobile communication carrier, and a vender of a browser program. The browser engine module 1052 of the above described embodiment corresponds to the first module, and the invocation management module 1051 and the dedicated modules 1053 and 1054 correspond to the second module. When various types of browser programs corresponding to the second technical specification are developed as derivatives based on the first technical specification, it becomes possible to eliminate the need for implementing the function defined by the first technical standard on the derivatives for each of the specifications of the derivatives by employing the above described configuration. Therefore, the development efficiency for the browser program can be enhanced. In particular, when the first technical specification is a standard technology and the second technical standard is a private technical specification, it is preferable that the first module is an open source browser engine. By thus configuring the browser program, the vender is not required to develop a program for supporting the standard technology, and thereby it becomes possible to concentrate on work for supporting the technical specification defined by a system operator, such as a mobile communication carrier, and the vender's own technical development. Therefore, the development efficiency of the program is enhanced considerably, and dramatic progress of browser technology can be realized.

In an embodiment of the invention, when a predetermined element is included in the content data, the second module alters or deletes the predetermined element based on a predetermined rule or adds another element to the content data.

In this case, the second module may add, to the content data, a script defining a command contained in the altered element or the added element. Further, the second module may change the content data which is generated in accordance with the second technical specification which the first module is not able to process, to content data which the first module is able to process. For example, the second module may change an element defined by the second technical specification to an element complying with the first technical specification. In this case, the second module may process the further changed element in place of the first module.

In an embodiment of the invention, the second module includes a management unit and one or more dedicated modules. In this case, the management module unit determines which of the first module and the one or more dedicated modules should be used to process the element included in the content data. In the explanation of the above described embodiment, the invocation management module 1051 corresponds to the management unit, and the dedicated modules 1053 and 1054 correspond to the dedicated modules explained herein.

1. A computer-readable medium having computer-readable instructions stored thereon, which, when executed by a processor of a computer, which generates drawing data for displaying contents described in a markup language on a display based on content data, configures the processor to function as:
a plurality of modules on which different functions are implemented respectively; and
a module management unit which manages the plurality of browser modules,
wherein:
one of the plurality of modules is a rendering module which generates the drawing data by rendering the content data;
at least one of the plurality of modules is a dedicated module which replaces or changes a part of functions of the rendering module or adding another function to the functions of the rendering module; and
based on a predetermined condition, the module management unit determines which of dedicated modules should be used to process elements included in the content data, and to cause the rendering module to process the content data on which predetermined alteration is made,
wherein:
the module management unit comprises:
an element extraction unit which searches the content data to extract the elements to be processed by using the dedicated module;
a content data alteration unit which makes the predetermined alteration on the content data based on a result of extraction by the element extraction unit;
a module invocation unit which invokes the dedicated module corresponding to the alteration; and
a content transmission unit which passes the altered contents to the rendering module,
wherein the rendering module causes the invoked dedicated module to process an altered part of the contents, and renders the contents by using a execution result by the dedicated module.

2. (canceled)

3. The computer-readable medium according to claim 1, wherein the content data alteration unit inserts, into the content data, a predetermined element to which predetermined control information is added.

4. The computer-readable medium according to claim 3, wherein the predetermined control information is information for calling the dedicated module and adding a function of the dedicated module to the functions of the rendering module.

5. The computer-readable medium according to claim 4, wherein the predetermined control information includes identification information which the dedicated module uses to access the predetermined element.

6. The computer-readable medium according to claim 1, wherein the content data alteration unit makes the predetermined alteration within a scope where the rendering module is able to analyze the contents.

7. The computer-readable medium according to claim 1,
wherein:
a request to a server is sent by the rendering module; and
the browser module management unit intercepts a response to the request, and executes an element extraction process by the element extraction unit, a content alteration process by the content data alteration unit, a browser module invocation process by the module invocation unit, and a content transmission process by the content transmission unit.

8. The computer-readable medium according to claim 1, wherein the rendering module is an open source browser module.

9. (canceled)

10. A terminal device, comprising:
a storage unit comprising a computer-readable medium having computer-readable instructions stored thereon;
a processor for executing computer-readable instructions, the computer-readable instructions configuring the processor to function as:
a plurality of modules on which different functions are implemented respectively; and
a module management unit which manages the plurality of browser modules,
wherein:
one of the plurality of modules is a rendering module which generates the drawing data by rendering the content data;
at least one of the plurality of modules is a dedicated module which replaces or changes a part of functions of the rendering module or adding another function to the functions of the rendering module; and
based on a predetermined condition, the module management unit determines which of dedicated modules should be used to process elements included in the content data, and to cause the rendering module to process the content data on which predetermined alteration is made,
wherein:
the module management unit comprises:
an element extraction unit which searches the content data to extract the elements to be processed by using the dedicated module;
a content data alteration unit which makes the predetermined alteration on the content data based on a result of extraction by the element extraction unit;
a module invocation unit which invokes the dedicated module corresponding to the alteration; and
a content transmission unit which passes the altered contents to the rendering module,
wherein the rendering module causes the invoked dedicated module to process an altered part of the contents, and renders the contents by using a execution result by the dedicated module; and
a display unit that displays the rendered contents.

11. A terminal device generating drawing data for displaying contents described in a markup language based on content data, comprising:
a plurality of modules on which different functions are implemented respectively; and
a module management unit which manages the plurality of modules,
wherein:
one of the plurality of modules is a rendering module which generates the drawing data by rendering the content data;
at least one of the plurality of modules is a dedicated module which replaces or changes a part of functions of the rendering module or adding another function to the functions of the rendering module; and
based on a predetermined condition, the module management unit determines which of dedicated modules should be used to process elements included in the content data, and to cause the rendering module to process the content data on which predetermined alteration is made,
wherein:
the module management unit comprises:
an element extraction unit which searches the content data to extract the elements to be processed by using the dedicated module;
a content data alteration unit which makes the predetermined alteration on the content data based on a result of extraction by the element extraction unit;
a module invocation unit which invokes the dedicated module corresponding to the alteration; and
a content transmission unit which passes the altered contents to the rendering module,
wherein the rendering module causes the invoked dedicated module to process an altered part of the contents, and renders the contents by using a execution result by the dedicated module.
